(19) United States
(12) Patent Application Publication
(10) Pub. No.: US 2023/0047948 A1
(43) Pub. Date: Feb. 16, 2023

(54) METHOD AND SYSTEM FOR PROVIDING A CRYPTOCURRENCY SECURED BY ONE OR MORE LOANS

(71) Applicant: Genusense Technologies, Inc., Palm Beach Gardens, FL (US)

(72) Inventor: Steven Shakespeare, Palm Beach Gardens, FL (US)

(73) Assignee: Genusense Technologies, Inc., Pam Beach Gardens, FL (US)

(21) Appl. No.: 17/885,866

(22) Filed: Aug. 11, 2022

Related U.S. Application Data
(60) Provisional application No. 63/260,230, filed on Aug. 12, 2021.

(51) Int. Cl. G06Q 40/02; G06Q 40/04

(52) U.S. Cl. CPC G06Q 40/025; G06Q 40/04; G06Q 2220/00

(57) ABSTRACT

A cryptocurrency secured by one or more loans is disclosed. The cryptocurrency is associated with one or more loans and the loan payments are distributed to the owner of the cryptocurrency. An identification of a pool of one or more bundled loans is received, and an indication of payments of the one or more bundled loans in the pool is be received. User information associated with a cryptocurrency exchange may be received, and the cryptocurrency is associated with the pool of one or more bundled loans. Transfer is made, to a user, of an amount of the payments of the one or more bundled loans in the pool.

### RELATED APPLICATIONS

The present application claims the priority to and benefit of U.S. Provisional Pat. No. 63/260,230, filed on Aug. 12, 2021, and entitled “Method and System for Securing Cryptocurrencies with Loans,” which is incorporated by reference herein.

### FIELD OF THE DISCLOSURE

The present disclosure relates to cryptocurrency, and more particularly to systems, methods, and storage media for providing a cryptocurrency secured by one or more loans.

### BACKGROUND

A mortgage-backed security (MBS) is a type of financial instrument (e.g., asset-backed security) that is secured by one or more mortgages. Where there are multiple mortgages securing the MBS, the mortgages are aggregated or “pooled.” The pooled mortgages are then sold to one or more entities (e.g., a government agency or investment back) that packages or “securitizes” the mortgages together into a security that investors can buy. Depending on whether the underlying assets are residential or commercial real estate, bonds, securitizing the mortgages may be treated as separate classes. A given MBS may be structured as a “pass-through” in which interest or principal payments from the borrower(s) pass through to the MBS holder(s).

Assets backed by loans including home or real estate loans are not easily accessible to investors in a decentralized and efficient way. For example, mortgage-backed securities (“MBS”) are bonds secured by home and other real estate loans. Investors may face one or more problems when they decide to purchase MBS’s. A problem faced by investors who wish to purchase MBS’s is high minimum investments. The minimum investment for some MBS’s can cost $1,000 or even $25,000. These minimum investments are a barrier to entry for many investors. Another problem that may be faced by investors who wish to purchase MBS’s is accessibility friction caused by requirement of broker involvement in the MBS purchase. An MBS investor may likely have to make an appointment to physically meet with a broker to purchase MBS’s. MBS’s may suffer from security weaknesses due to confirmation of individual transactions occurring on one or a few centralized computers.

MBS bonds are created and sold through a complex network of banks, federal government agencies, government sponsored enterprises, securities firms, and brokers. The process for creating an MBS starts when banks group home and real estate loans together in pools comprising loans with similar characteristics. These pooled loans are then sold to a federal government agency like the Government National Mortgage Association® (“Ginnie Mae”), to government sponsored enterprises like the Federal National Mortgage Association® (“Fannie Mae”) or the Federal Home Loan Mortgage Corporation® (“Freddie Mac”), or to securities firms to be included in new MBS’s. Finally, the MBS’s are sold to investors in a highly centralized way through banks or brokers. MBS investors then receive monthly disbursements collected from the interest and principal payments from the pooled MBS loans. Centralized computers used to perform and confirm MBS transactions and/or payouts are vulnerable to bad actors seeking to perform counterfeit transactions and/or payouts or erase records associated with authentic investments.

Conventional MBS’s involve technical friction and shortcomings. For example, securitizing the underlying mortgages can involve centralized computing resources that fail to provide sufficient transparency and security. Moreover, these systems are generally not directly accessible to individual investors who wish to purchase such securities. That means that middlemen (e.g., brokers) are required to facilitate transactions.

### SUMMARY

In one aspect, a method in a data processing system for providing a cryptocurrency secured by one or more loans, the method includes receiving an identification of a pool of one or more bundled loans, receiving an indication of payments of the one or more bundled loans in the pool, receiving user information associated with a cryptocurrency exchange, the cryptocurrency exchange being associated with the cryptocurrency, associating the cryptocurrency with the pool of one or more bundled loans, and transferring, to an account of a user associated with the user information, an amount of the payments of the one or more bundled loans in the pool based on cryptocurrency associated with the user and within the cryptocurrency exchange.

In one aspect, a data processing system configured for providing a cryptocurrency secured by one or more loans, the data processing system includes a memory having executable instructions embodied thereon. The data processing system configured also includes one or more hardware processors configured to execute the instructions to receive an identification of a pool of one or more bundled loans, where the one or more bundled loans includes two or more loans grouped together, receive an indication of payments of the one or more bundled loans in the pool, where the payments of the one or more bundled loans in the pool includes scheduled payments by one or more loan recipients toward interest or principal of one or more bundled loans, receive user information associated with a cryptocurrency exchange, the cryptocurrency exchange being associated with the cryptocurrency, where the cryptocurrency provides access to funds from the payments in a custodial account, associate the cryptocurrency with the pool of one or more bundled loans, and transfer, to an account of a user associated with the user information, an amount of the payments of the one or more bundled loans in the pool based on cryptocurrency within the cryptocurrency exchange, where the amount of the payments distributed to the user is determined based on a percentage of the cryptocurrency owned or associated with the user.

In one aspect, one or more computer-readable memories having instructions embodied thereon, the instructions being executable by one or more processors to perform a method for providing a cryptocurrency secured by one or more loans, the method includes receiving an identification of a pool of one or more bundled loans, where the one or more bundled loans includes two or more loans grouped together, receiving an indication of payments of the one or more bundled loans in the pool, where the payments of the one or more bundled loans in the pool includes scheduled payments by one or more loan recipients toward interest or principal of the one or more bundled loans, where the payments of some or all of the one or more bundled loans in the pool are collected or stored in a custodial account, receiving user information associated with a cryptocurrency exchange, the cryptocurrency exchange being associated with the cryptocurrency, the cryptocurrency being associated with some or all of the one or more bundled loans in the pool, where the cryptocurrency provides access to funds from the payments in the custodial account, and transferring, to an account of a user associated with the user information, an amount of the payments of some or all of the one or more bundled loans in the pool based on cryptocurrency within the cryptocurrency exchange, where the amount of the payments distributed to the user is determined based on a percentage of the cryptocurrency owned or associated with the user, and where the amount of the payments distributed to the user are accessible to the user via a decentralized application.

### BRIEF DESCRIPTION OF THE DRAWINGS

FIG. 1 illustrates an example system configured for providing a secured cryptocurrency with mortgage payment disbursement components, in accordance with one or more implementations.

FIG. 2 illustrates an example process for mortgage payment disbursement performed by the system of FIG. 1, in accordance with one or more implementations.

FIG. 3 illustrates an example system configured for providing a secured cryptocurrency with purchase and loan pool payment disbursement components, in accordance with one or more implementations.

FIG. 4 illustrates an example process for purchase and loan pool payment collections disbursement performed by the system of FIG. 3, in accordance with one or more implementations.

FIG. 5 illustrates an example of decentralized blockchain nodes configured to provide transaction transparency for a secured cryptocurrency, in accordance with one or more implementations.

FIG. 6 illustrates a cryptocurrency platform configured for providing a cryptocurrency secured by one or more loans, in accordance with one or more implementations.

FIG. 7 is a flowchart of an example process 700 for providing a cryptocurrency secured by one or more loans, in accordance with one or more implementations.

FIG. 8 illustrates an example computer system to implement the processes.

### DETAILED DESCRIPTION

Implementations described herein secure cryptocurrencies with loans (e.g., mortgages). For example, some implementations allow users to purchase a cryptocurrency secured by one or more pooled loans and, through ownership of the cryptocurrency, automatically receive payouts from payments to the loans made by borrowers. Exemplary implementations remove the need for humans (e.g., brokers) to facilitate transactions with investors. Instead, an investor can purchase a so-called “mortgage-backed cryptocurrency” with just a few clicks on their mobile device or computer connected to the Internet. Moreover, the decentralized computational resources and underlying blockchain technology provide transparency and technical security that is lacking with conventional MBS’s, as well as reduce computational strain on the resources of a given computing device.

Cryptocurrencies are an encrypted form of digital currency that can be used for many transactions instead of physical currency such as the United States Dollar. Cryptocurrencies may involve a record keeping database technology known as blockchain (“BC”). The first cryptocurrency coin (“CC”) was Bitcoin, which was created in 2009. A cryptocurrency token (“CT”) is another form of digital asset that followed the creation of CCs. Unlike CCs, CTs exist on top of existing BC networks and do not have their own blockchain network. There can be numerous CTs associated with a specific BC network; however, only one CC may be associated with a specific BC network. Cryptocurrencies may be revolutionary; however, they also face problems. One such problem faced by cryptocurrencies is extreme market price volatility. The market price of many cryptocurrencies faces extreme volatility because most are not backed by traditionally accepted assets such as gold, properties, stocks, or bonds.

Decentralized BC technology may create transaction transparency as BC transactions can be reviewed by any computer that is part of the BC network. This decentralization disperses control of cryptocurrencies amongst users within the BC network and thereby enables greater equity than traditional currencies. A Decentralized application (“dApp”) is a digital application that allows users to access BC networks. The creation of cryptocurrencies and BC technology may be revolutionary; however, extreme cryptocurrency market price volatility discourages many investors from entering the cryptocurrency market.

A solution for problems associated with both MBS’s and cryptocurrencies is mortgage-backed cryptocurrencies (“MBC”). MBCs make assets backed by home or real estate loans more easily accessible to users in a decentralized and efficient way by removing the sizeable minimum investment requirements, and, by eliminating the friction caused by the need to purchase the security from a separate broker, MBCs also solve the problem of extreme market price volatility faced by many cryptocurrencies. Although referred to as MBCs, any type of loan may be used. A user can be an investor, corporation, or other buyer or seller, for example. In some implementations, an MBC is created by backing cryptocurrency digital assets such as CCs and CTs with more traditionally accepted home and real estate loan assets. Backing a cryptocurrency means that something is provided as collateral. Home and real estate loans are used as collateral for MBCs. MBCs are paid the proceeds of the assets that back the cryptocurrency. For example, if mortgages back the cryptocurrency, the loan payments are paid to the MBC owners. Owning MBCs therefore creates partial pool ownership for a user based upon the total share of MBCs possessed by the user.

The use of decentralized blockchain technology also creates greater transparency and creates greater accessibility by removing the need for banks or brokers to sell mortgage-backed digital assets to users. Traditional MBS’s involve user friction with banks and brokers due to sizable bank minimum investment amounts and the requirement that MBS’s be purchased from a broker. An MBC user does not have to physically meet or interact with a broker to purchase MBCs. The ease of accessibility associated with MBCs reduces the friction caused by broker involvement. In some implementations, an MBC user can purchase MBCs with just a few clicks on their mobile device or computer connected to the internet. Additionally, MBCs may have less market price volatility because they are backed by traditionally accepted home and real estate loans. MBCs also generate, for example, monthly revenue for users by disbursing monthly loan payments to users. Ultimately, MBCs resolve the deficiencies of both traditional MBS’s and cryptocurrencies by making assets backed by home or real estate loans more decentralized and easily accessible to users and by reducing extreme market price volatility.

As disclosed herein, a dApp provides enhanced security due to, for example, confirmation of individual transactions being performed by multiple decentralized computers instead of relying upon one or a few centralized computers. This also reduces computational strain on the resources of a given computer or processor. Both web apps and dApps used with MBCs streamline investment and payment processes when compared to traditional MBS’s because, for example, human brokers may not be needed to perform process steps. In addition, security and other risks associated with relying upon one or a few centralized computers (or computer systems) to confirm transactions are reduced by ensuring that multiple decentralized computers verify transactions across an entire blockchain, thus eliminating potential for a single point of failure.

MBCs may work by bundling individual home or real estate loans into a single pool containing multiple loans. The monthly payments including principal and interest may then be proportionally automatically dispersed to the MBC users. The disbursement may be based upon the user’s share of ownership of the cryptocurrency, which is backed by the pool of loans.

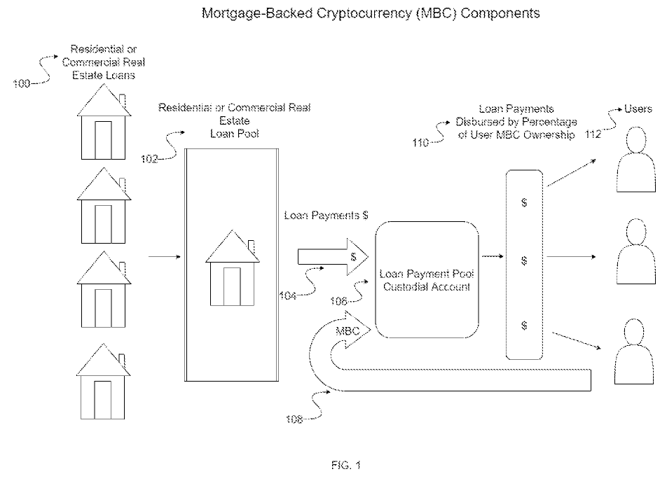

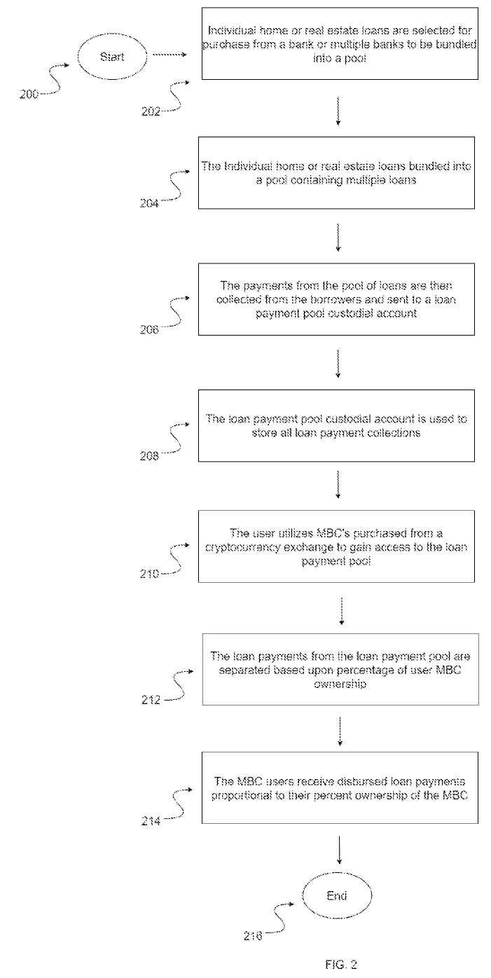

The system may provide a process for users to easily purchase cryptocurrencies backed by loans such as home or real estate loans. FIG. 1 and FIG. 2 illustrate how the system disburses pooled monthly loan payments to users who have purchased MBCs. Although described as home or real estate loan payments, it should be noted that any other type of suitable loan payment may also be used.

FIG. 1 illustrates an example system configured for providing a secured cryptocurrency with mortgage payment disbursement components, in accordance with one or more implementations. In FIG. 1, one or more individual home or real estate loans 100 may be grouped into a home or real estate loan pool 102. Loan payments 104 may be made into loan payment pool custodial account 106, which may be accessible through one or more MBCs 108. In some implementations, loan payments 110 are automatically transferred and disbursed to users 112 associated with MBCs 108 by percentage of user MBC ownership.

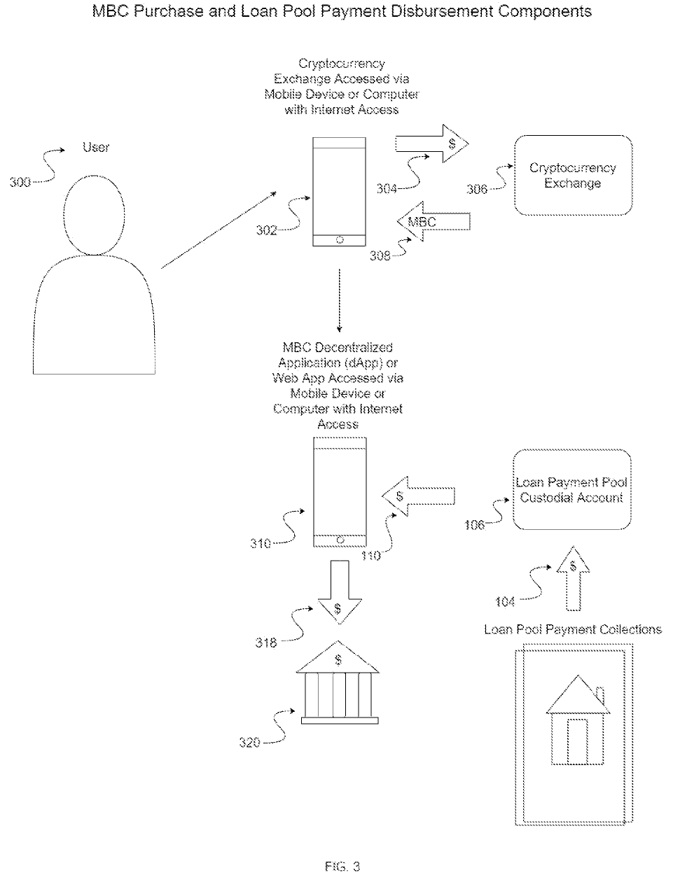

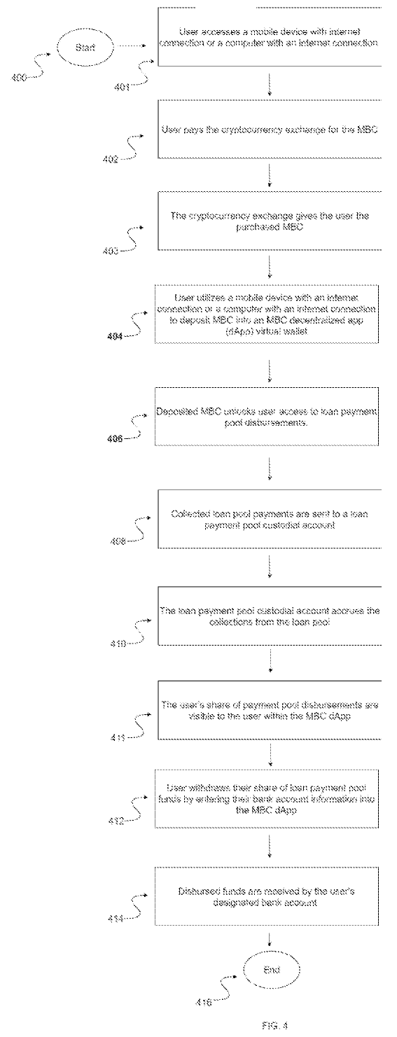

FIG. 2 illustrates an example process for mortgage payment disbursement performed by the system of FIG. 1, in accordance with one or more implementations. Loans may be acquired through purchase from bank lenders and then bundled into a loan pool. For example, in step 200, the MBC process starts with individual home or real estate loans 100. In step 202, individual home or real estate loans are selected for purchase from a bank or multiple banks to be bundled into a pool. In step 204, individual home or real estate loans bundled into a pool containing multiple loans 102. In step 206, payments from the pool of loans 104 are collected from the borrowers and sent to a loan payment pool custodial account 106. In step 208, in one implementation, the loan payment pool custodial account 106 is used to store all loan payment collections. In step 210, the user uses MBCs 108 purchased from a cryptocurrency exchange to gain access to the loan payment pool. In step 212, loan payments from the loan payment pool 110 are separated based upon percentage of user MBC ownership. In step 214, the MBC users 112 receive disbursed loan payments proportional to their percent ownership of the MBC. In step 216, the process ends and then restarts with the next loan payment cycle. For this process to occur, the MBC user may purchase the MBC from a cryptocurrency exchange and then use an MBC dApp to manage the recurring loan payment disbursements as shown in FIG. 3 and FIG. 4.

FIG. 3 illustrates an example system configured for providing a secured cryptocurrency with purchase and loan pool payment disbursement components, in accordance with one or more implementations. In FIG. 3, a user 300 may use Internet connected user device 302 to make payments 304 to cryptocurrency exchange 306 and obtain MBC 308. A user device 310 running an MBC dApp may provide loan payment pool funds 318 the user’s designated bank account 320. Loan pool payment collections 104 may be deposited into loan payment pool custodial account 106 where the user’s share of payment pool disbursements 110 may be sent to the user via the MBC dApp running on user device 310.

FIG. 4 illustrates an example process for purchase and loan pool payment collections disbursement performed by the system of FIG. 3, in accordance with one or more implementations. In step 400, the user 300 starts the process of purchasing the MBC to receive disbursements from the loan payment pool. In step 401, the user accesses a mobile device with internet connection or a computer with a user device 302. In step 402, the user pays 304 the cryptocurrency exchange 306. In step 403, the cryptocurrency exchange 306 gives the user access to the purchased MBC 308. In step 404, the user uses a mobile device with an internet connection or a computer with an internet connected user device 310 running an MBC dApp to deposit MBC into an MBC dApp virtual wallet. The MBC dApp virtual wallet may include a storage place for MBC, which may be organized based on by unique users. For example, a given user may have their own unique MBC dApp virtual wallet to hold their MBCs. In some implementations, the MBC dApp virtual wallet may be accessed using a web application instead of or in addition to a dApp (e.g., if virtual wallets are centralized). In step 408, collected loan pool payments 104 are sent to a loan payment pool custodial account 106. In step 410, the loan payment pool custodial account 104 accrues the collections from the loan pool. In step 411, the user’s share of payment pool disbursements 110 are visible to the user within the MBC dApp. In step 412, the user withdraws their share of loan payment pool funds 318 by entering their bank account information into the MBC dApp via user device 310. In step 414, withdrawn funds are received by the user’s designated bank account 320. Finally, in step 416, the process ends and then restarts with the next loan cycle. The user can also choose to adjust the settings in the MBC dApp via user device 310 to have their share of loan payment pool funds automatically withdrawn to the same designated bank account each loan cycle.

For example, if there are 20,000,000 total MBCs in circulation that are backed by a home or real estate loan pool totaling $360,000,000 USD in unpaid principal balance (UPB), and the monthly loan payment pool custodial account contained $1,000,000 USD in collections at the end of a given cycle, then a user who deposited 10,000 MBCs into the MBC dApp virtual wallet may be able to withdraw their share of loan payment pool collections totaling $1,000.00 minus servicing fees at the end of that cycle.

Furthermore, in another example, if a user uses his mobile phone to purchase 5,000 MBCs from a cryptocurrency exchange, while there are 20,000,000 total MBCs in circulation and $1,000,000 USD in collections at the end of a given cycle in the loan payment pool custodial account, that user will be able to access the MBC dApp using his mobile phone to withdraw his total share of $500 minus service fees to his bank account.

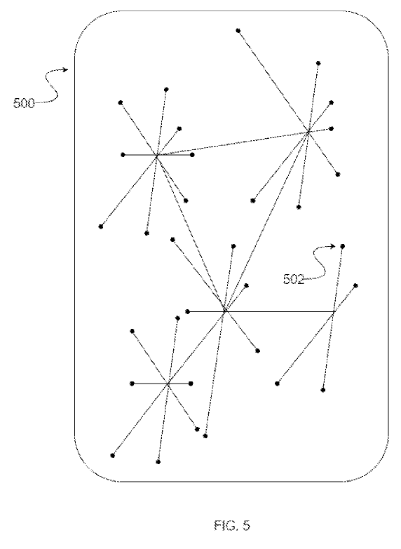

FIG. 5 illustrates an example of decentralized blockchain nodes configured to provide transaction transparency for a secured cryptocurrency, in accordance with one or more implementations. For example, the BC network 500 may contain individual computer nodes 502. Computer nodes 502 may be interconnected and contain the entirety of the MBC distributed ledger. Each node 502 consists of an electronic device connected to the BC network and possessing an Internet Protocol (IP) address.

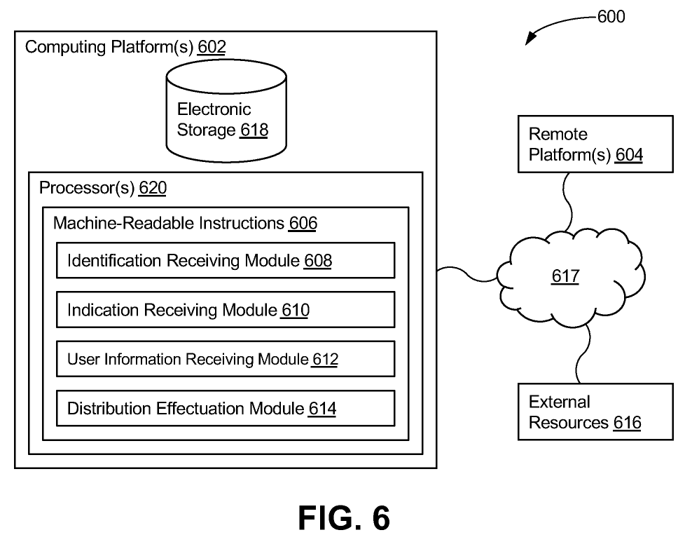

FIG. 6 illustrates a cryptocurrency platform 600 configured for providing a cryptocurrency secured by one or more loans, in accordance with one or more implementations. FIG. 6 may include one or more devices and/or components described in connection with FIGS. 1-5. In some implementations, cryptocurrency platform 600 may include one or more computing platforms 602. Computing platform(s) 602 may be configured to communicate with one or more remote platforms 604 according to a client/server architecture, a peer-to-peer architecture, and/or other architectures. Remote platform(s) 604 may be configured to communicate with other remote platforms via computing platform(s) 602 and/or according to a client/server architecture, a peer-to-peer architecture, and/or other architectures. Users may access cryptocurrency platform 600 via remote platform(s) 604.

Computing platform(s) 602 may be configured by machine-readable instructions 606. Machine-readable instructions 606 may include one or more instruction modules. The instruction modules may include computer program modules. The instruction modules may include one or more of identification receiving module 608, indication receiving module 610, user information receiving module 612, transfer effectuation module 614, and/or other instruction modules.

The disclosed implementations and examples may be described in the general context of computer code or machine-useable instructions, including computer-executable instructions such as program modules, being executed by a computer or other machine. Generally, machine-useable instructions define various software routines, programs, objects, components, data structures, remote procedure calls (RPCs), and the like. In operation, these instructions perform computational tasks, such as requesting and retrieving information stored on a remote computing device, server, virtual machine, or the like.

Identification receiving module 608 may be configured to receive an identification of a pool of one or more bundled loans. For example, the identification of the pool may include one or more of a name, a number, a code, an alphanumeric sequence, a binary number, a hexadecimal number, or a symbol. The one or more bundled loans may include two or more loans grouped together. The pool may include a group of loans.

One or more loans may be selected to be bundled into the pool. For example, the one or more loans to be bundled into the pool may be selected based on one or more of loan type, loan amount, loan issue date, loan payoff date, loan payoff schedule, loan terms, geolocation associated with loan, credit score of loan recipients, or demographics of loan recipients.

The one or more selected loans may be bundled into the pool. In some implementations, the bundled loans may include two or more loans of the same type or of different types. For example, a given loan may include one or more of a mortgage, a home loan, a real estate loan, a commercial loan, a business loan, an automobile loan, a boat loan, an education loan, a debt consolidation loan, or a payday loan.

Indication receiving module 610 may be configured to receive an indication of payments of some or all of the one or more bundled loans in the pool. For example, the indication of payments of some or all of the one or more bundled loans in the pool may include one or more of information conveying that one or more payments was made, information conveying that funds associated with one or more payments was deposited in a custodial account, occurrence of a scheduled payment date, occurrence of a predetermined day of a week, occurrence of a predetermined day of a month, or occurrence of a predetermined day of a year. The indication may be received in response to one or more of one or more payments being made, funds associated with one or more payments being deposited in a custodial account, occurrence of a scheduled payment date, occurrence of a predetermined day of a week, occurrence of a predetermined day of a month, or occurrence of a predetermined day of a year. The payments of some or all of the one or more bundled loans in the pool may include scheduled payments by one or more loan recipients toward interest or principal of one or more bundled loans.

The payments may be received in a fiat currency. The fiat currency may include money that is made legal tender by a government decree. The fiat currency may include money that is issued and backed by a government.

The payments of some or all of the one or more bundled loans in the pool may be collected or stored in a custodial account. The custodial account may include a financial account established for a benefit of one or more beneficiaries and administered by a responsible entity.

User information receiving module 612 may be configured to receive user information associated with a cryptocurrency exchange. For example, the user information may include one or more of a name, a username, a user identification, a user handle, bank information of the user, amount of the cryptocurrency owned or associated with the user, or account information of the user. The user information may be received in response to the payments of some or all of the one or more bundled loans in the pool being received in the custodial account.

The cryptocurrency exchange may be associated with a cryptocurrency. The cryptocurrency may include a digital currency with transactions being verified and recorded by a decentralized system using cryptography. The cryptocurrency may be associated with some or all of the one or more bundled loans in the pool. In some implementations, the cryptocurrency may be associated with some or all of the one or more bundled loans in the pool in a database, such as by using database identifications (“IDs”) for the cryptocurrency and one or more corresponding loans and/or pools (e.g., as pairs). In some implementations, individual tokens of the cryptocurrency may be identified with a serial number in an MBC process. Specific classes of cryptocurrencies (e.g., single family, multifamily, senior living, commercial, student housing, etc.) may be tied to specific and/or unique pools that only contain assets of the same class. That is, one class of MBC may be tied to one pool of the same class. The cryptocurrency may provide access to funds from the payments in the custodial account. The user may access the cryptocurrency exchange via a user device. For example, the user device may include one or more of a mobile device, a smart phone, a personal computer, a tablet, a laptop computer, or a desktop computer.

The cryptocurrency exchange may include a platform through which the cryptocurrency can be exchanged for one or more fiat currencies. Paying through or to the cryptocurrency exchange may include providing one or both of an amount of fiat currency or an amount of a different cryptocurrency. The different cryptocurrency may include any cryptocurrency that is different from the cryptocurrency managed by the cryptocurrency exchange. For example, the different cryptocurrency may include one or more of Bitcoin, Ethereum, ApeCoin, Uniswap, Dogecoin, Binance Coin, Solana, Polkadot, Shiba Inu, or Avalanche. For example, the amount of the different cryptocurrency paid in exchange for the amount of cryptocurrency managed by the cryptocurrency exchange may be determined based on one or more of a market rate, a predetermined rate, a rate associated with the different cryptocurrency, or a rate associated with the fiat currency.

The user may purchase or becomes associated with an amount of cryptocurrency managed by the cryptocurrency exchange by paying through or to the cryptocurrency exchange. For example, the amount of the fiat currency paid in exchange for the amount of cryptocurrency managed by the cryptocurrency exchange may be determined based on one or more of a market rate, a predetermined rate, a rate associated with the different cryptocurrency, or a rate associated with the fiat currency. The cryptocurrency purchased or associated with the user may be stored via a decentralized application virtual wallet associated with the user.

The cryptocurrency may include one or both of one or more coins or one or more tokens. A given coin of the cryptocurrency may include a representation of digital value that is stored on a given blockchain or cryptocurrency network. A given token of the cryptocurrency may include a unit of value on a blockchain that has some other value proposition besides a transfer of value.

Transfer effectuation module 614 may be configured to transfer or effectuate transfer, to a user, an amount of the payments of some or all of the one or more bundled loans in the pool. The amount of the payments distributed to the user may be determined based on a percentage of the cryptocurrency owned or associated with the user. For example, the percentage of the cryptocurrency owned or associated with the user may be determined based on one or more of an amount of the cryptocurrency owned or associated with the user, a total amount of the cryptocurrency issued to all users, a total amount of the cryptocurrency that has been mined, or a total amount of the cryptocurrency that can be mined.

The amount of the payments distributed to the user may be accessible to the user via a decentralized application. The decentralized application may be configured to transfer some or all of the amount of the payments distributed to the user via a bank account associated with the user.

In some implementations, computing platform(s) 602, remote platform(s) 604, and/or external resources 616 may be operatively linked via one or more electronic communication links. For example, such electronic communication links may be established, at least in part, via a network 617 such as the Internet and/or other networks. It will be appreciated that this is not intended to be limiting, and that the scope of this disclosure includes implementations in which computing platform(s) 602, remote platform(s) 604, and/or external resources 616 may be operatively linked via some other communication media.

A given remote platform 604 may include one or more processors configured to execute computer program modules. The computer program modules may be configured to enable an expert or user associated with the given remote platform 604 to interface with cryptocurrency platform 600 and/or external resources 616, and/or provide other functionality attributed herein to remote platform(s) 604. For example, a given remote platform 604 and/or a given computing platform 602 may include one or more of a server, a desktop computer, a laptop computer, a handheld computer, a tablet computing platform, a NetBook, a Smartphone, a gaming console, an augmented reality or virtual reality device, and/or other computing platforms.

External resources 616 may include sources of information outside of cryptocurrency platform 600, external entities participating with cryptocurrency platform 600, and/or other resources. In some implementations, some or all of the functionality attributed herein to external resources 616 may be provided by resources included in cryptocurrency platform 600.

Computing platform(s) 602 may include electronic storage 618, one or more processors 620, and/or other components. Computing platform(s) 602 may include communication lines, or ports to enable the exchange of information with a network and/or other computing platforms. Illustration of computing platform(s) 602 in FIG. 6 is not intended to be limiting. Computing platform(s) 602 may include a plurality of hardware, software, and/or firmware components operating together to provide the functionality attributed herein to computing platform(s) 602. For example, computing platform(s) 602 may be implemented by a cloud of computing platforms operating together as computing platform(s) 602.

Electronic storage 618 may comprise non-transitory storage memory, including memory devices, that electronically stores information. The electronic storage memory of electronic storage 618 may include one or both of system storage that is provided integrally (i.e., partially non-removable) with computing platform(s) 602 and/or removable storage that is removably connectable to computing platform(s) 602 via, for example, a port (e.g., a USB port, a firewire port, etc.) or a drive (e.g., a disk drive, etc.). Electronic storage 618 may include one or more of optically readable storage media (e.g., optical disks, etc.), magnetically readable storage media (e.g., magnetic tape, magnetic hard drive, floppy drive, etc.), electrical charge-based storage media (e.g., electrically erasable programmable read-only memory (“EEPROM”), random-access memory (“RAM”), etc.), solid-state storage media (e.g., flash drive, etc.), and/or other electronically readable storage media. Electronic storage 618 may include one or more virtual storage resources (e.g., cloud storage, a virtual private network, and/or other virtual storage resources). Electronic storage 618 may store software algorithms, information determined by processor(s) 620, information received from computing platform(s) 602, information received from remote platform(s) 604, and/or other information that enables computing platform(s) 602 to function as described herein.

Processor(s) 620 may be configured to provide information processing capabilities in computing platform(s) 602. As such, processor(s) 620 may include one or more of a digital processor, an analog processor, a digital circuit designed to process information, an analog circuit designed to process information, a state machine, and/or other mechanisms for electronically processing information. Although processor(s) 620 is shown in FIG. 6 as a single entity, this is for illustrative purposes only. In some implementations, processor(s) 620 may include a plurality of processing units. These processing units may be physically located within the same device, or processor(s) 620 may represent processing functionality of a plurality of devices operating in coordination. Processor(s) 620 may be configured to execute modules 608, 610, 612, and/or 614, and/or other modules. Processor(s) 620 may be configured to execute modules 608, 610, 612, and/or 614, and/or other modules by software; hardware; firmware; some combination of software, hardware, and/or firmware; and/or other mechanisms for configuring processing capabilities on processor(s) 620. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 608, 610, 612, and/or 614 are illustrated in FIG. 6 as being implemented within a single processing unit, in implementations in which processor(s) 620 includes multiple processing units, one or more of modules 608, 610, 612, and/or 614 may be implemented remotely from the other modules. The description of the functionality provided by the different modules 608, 610, 612, and/or 614 described below is for illustrative purposes, and is not intended to be limiting, as any of modules 608, 610, 612, and/or 614 may provide more or less functionality than is described. For example, one or more of modules 608, 610, 612, and/or 614 may be eliminated, and some or all of its functionality may be provided by other ones of modules 608, 610, 612, and/or 614. As another example, processor(s) 620 may be configured to execute one or more additional modules that may perform some or all of the functionality attributed below to one of modules 608, 610, 612, and/or 614.

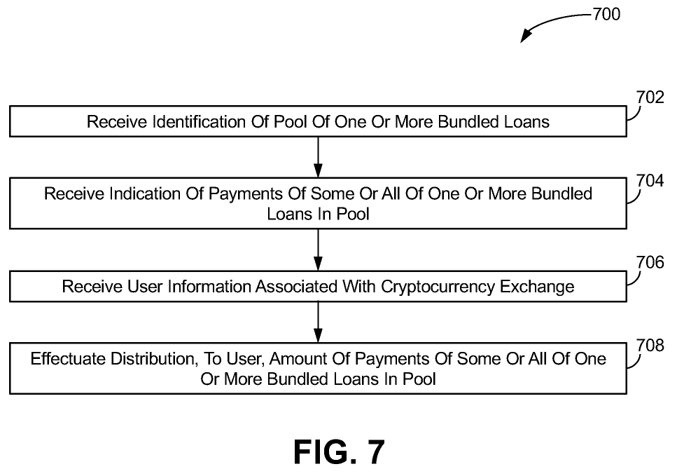

FIG. 7 is a flowchart of an example process 700 for providing a cryptocurrency secured by one or more loans, in accordance with one or more implementations. In some implementations, one or more process step of FIG. 7 may be performed by a device including one or more of computing platform(s) 602, remote platform(s) 604, and/or other devices. In some implementations, one or more process step of FIG. 7 may be performed by another device or a group of devices separate from or including the device.

As shown at step 702, process 700 may include receiving an identification of a pool of one or more bundled loans. For example, the device (e.g., using one or more of computing platform(s) 602, remote platform(s) 604, electronic storage 618, processors 620, identification receiving module 608, other component(s) from one or more devices described herein, and/or the like) may perform receiving an identification of a pool of one or more bundled loans, as described above.

As shown at step 704, process 700 may include receiving an indication of payments of some or all of the one or more bundled loans in the pool. For example, the device may perform receiving an indication of payments of some or all of the one or more bundled loans in the pool, as described above.

As shown at step 706, process 700 may include automatically transfer or receiving user information associated with a cryptocurrency exchange. The cryptocurrency exchange may be associated with a cryptocurrency. For example, the device may perform receiving user information associated with a cryptocurrency exchange. The cryptocurrency exchange may be associated with a cryptocurrency, as described above. The system also associates the cryptocurrency with a loan or pool of loans.

As shown at step 708, process 700 may include effectuating transfer, to a user, an amount of the payments of some or all of the one or more bundled loans in the pool. For example, the device may perform effectuating transfer, to a user, an amount of the payments of some or all of the one or more bundled loans in the pool, as described above. According to some implementations, such transfer may include calculating the user’s share or portion of the loan payment pool based upon the percentage of MBC deposited or staked (e.g., using a dApp). The user may enter their banking deposit information into the dApp to receive their portion of the loan payments. In some implementations, the calculated payment may be dispersed to the user on a monthly basis (or other basis) as long as the user has staked or deposited the MBC within via the dApp. In some implementations, unique cryptocurrency wallets may be provided for a given user to will hold their deposited or staked MBC.

Process 700 may include additional implementations, such as any single implementation or any combination of implementations described herein and/or in connection with one or more other processes described elsewhere herein.

Although FIG. 7 shows example steps of process 700, in some implementations, process 700 may include additional steps, fewer steps, different steps, or differently arranged steps than those depicted in FIG. 7. Additionally, or alternatively, two or more of the steps of process 700 may be performed in parallel.

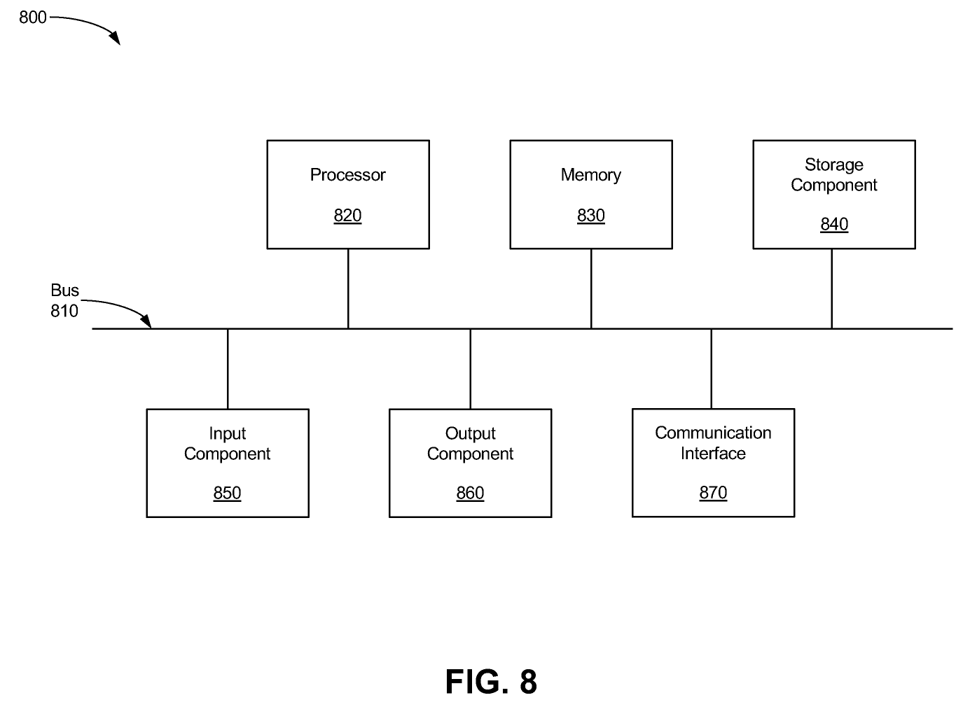

FIG. 8 is a diagram of example components of a device 800, which may correspond to one or more of computing platform(s) 602, remote platform(s) 604, and/or other device(s) described herein. In some implementations, computing platform(s) 602, remote platform(s) 604, and/or other devices described herein include one or more devices 800 and/or one or more components of device 800. As shown in FIG. 8, device 800 may include a bus 810, a processor 820, a memory 830, an input component 840, an output component 850, and a communication component 860.

Bus 810 includes one or more components that enable wired and/or wireless communication among the components of device 800. Bus 810 may couple together two or more components of FIG. 8, such as via operative coupling, communicative coupling, electronic coupling, and/or electric coupling. Processor 820 includes a central processing unit, a graphics processing unit, a microprocessor, a controller, a microcontroller, a digital signal processor, a field-programmable gate array, an application-specific integrated circuit, and/or another type of processing component. Processor 820 is implemented in hardware, firmware, or a combination of hardware and software. In some implementations, processor 820 includes one or more processors capable of being programmed to perform one or more operations or processes described elsewhere herein.

Memory 830 includes volatile and/or nonvolatile memory. For example, memory 830 may include random access memory (RAM), read only memory (ROM), a hard disk drive, and/or another type of memory (e.g., a flash memory, a magnetic memory, and/or an optical memory). Memory 830 may include internal memory (e.g., RAM, ROM, or a hard disk drive) and/or removable memory (e.g., removable via a universal serial bus connection). Memory 830 may be a non-transitory computer-readable medium. Memory 830 stores information, instructions, and/or software (e.g., one or more software applications) related to the operation of device 800. In some implementations, memory 830 includes one or more memories that are coupled to one or more processors (e.g., processor 820), such as via bus 810.

Input component 840 enables device 800 to receive input, such as user input and/or sensed input. For example, input component 840 may include a touch screen, a keyboard, a keypad, a mouse, a button, a microphone, a switch, a sensor, a global positioning system sensor, an accelerometer, a gyroscope, and/or an actuator. Output component 850 enables device 800 to provide output, such as via a display, a speaker, and/or a light-emitting diode. Communication component 860 enables device 800 to communicate with other devices via a wired connection and/or a wireless connection. For example, communication component 860 may include a receiver, a transmitter, a transceiver, a modem, a network interface card, and/or an antenna.

Device 800 may perform one or more operations or processes described herein. For example, a non-transitory computer-readable medium (e.g., memory 830) may store a set of instructions (e.g., one or more instructions or code) for execution by processor 820. Processor 820 may execute the set of instructions to perform one or more operations or processes described herein. In some implementations, execution of the set of instructions, by one or more processors 820, causes the one or more processors 820 and/or the device 800 to perform one or more operations or processes described herein. In some implementations, hardwired circuitry is used instead of or in combination with the instructions to perform one or more operations or processes described herein. Additionally, or alternatively, processor 820 may be configured to perform one or more operations or processes described herein. Thus, implementations described herein are not limited to any specific combination of hardware circuitry and software.

The number and arrangement of components shown in FIG. 8 are provided as an example. Device 800 may include additional components, fewer components, different components, or differently arranged components than those shown in FIG. 8. Additionally, or alternatively, a set of components (e.g., one or more components) of device 800 may perform one or more functions described as being performed by another set of components of device 800.

The foregoing disclosure provides illustration and description, but is not intended to be exhaustive or to limit the implementations to the precise form disclosed. Modifications and variations may be made in light of the above disclosure or may be acquired from practice of the implementations.

As used herein, the term “component” is intended to be broadly construed as hardware, firmware, or a combination of hardware and software.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code--it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

What is claimed is:

1. A method in a data processing system for providing a cryptocurrency secured by one or more loans, the method comprising:
receiving an identification of a pool of one or more bundled loans;
receiving an indication of payments of the one or more bundled loans in the pool;
receiving user information associated with a cryptocurrency exchange, the cryptocurrency exchange being associated with the cryptocurrency;
associating the cryptocurrency with the pool of one or more bundled loans; and
transferring, to an account of a user associated with the user information, an amount of the payments of the one or more bundled loans in the pool based on cryptocurrency associated with the user and within the cryptocurrency exchange.

2. The method of claim 1, wherein the one or more bundled loans includes two or more loans grouped together.

3. The method of claim 1, wherein the one or more bundled loans includes one or more of a mortgage, a home loan, a real estate loan, a commercial loan, a business loan, an automobile loan, a boat loan, an education loan, a debt consolidation loan, or a payday loan.

4. The method of claim 1, wherein the bundled loans include two or more loans of a same type or of different types.

5. The method of claim 1, wherein the indication of payments of the one or more bundled loans in the pool includes one or more of information conveying that one or more payments was made, and second information conveying that funds associated with the one or more payments was deposited in a custodial account, occurrence of a scheduled payment date, occurrence of a predetermined day of a week, occurrence of a predetermined day of a month, or occurrence of a predetermined day of a year.

6. The method of claim 1, wherein the payments of the one or more bundled loans in the pool includes scheduled payments by one or more loan recipients toward interest or principal of one or more bundled loans.

7. The method of claim 6, wherein the user accesses the cryptocurrency exchange via a user device, and wherein the user device includes one or more of a mobile device, a smart phone, a personal computer, a tablet, a laptop computer, or a desktop computer.

8. The method of claim 1, wherein the payments of the one or more bundled loans in the pool are collected or stored in a custodial account.

9. A data processing system configured for providing a cryptocurrency secured by one or more loans, the data processing system comprising:
a memory having executable instructions embodied thereon; and
one or more hardware processors configured to execute the instructions to:
receive an identification of a pool of one or more bundled loans, wherein the one or more bundled loans includes two or more loans grouped together;
receive an indication of payments of the one or more bundled loans in the pool, wherein the payments of the one or more bundled loans in the pool includes scheduled payments by one or more loan recipients toward interest or principal of one or more bundled loans;
receive user information associated with a cryptocurrency exchange, the cryptocurrency exchange being associated with the cryptocurrency, wherein the cryptocurrency provides access to funds from the payments in a custodial account;
associate the cryptocurrency with the pool of one or more bundled loans; and
transfer, to an account of a user associated with the user information, an amount of the payments of the one or more bundled loans in the pool based on cryptocurrency within the cryptocurrency exchange, wherein the amount of the payments distributed to the user is determined based on a percentage of the cryptocurrency owned or associated with the user.

10. The data processing system of claim 9, wherein the cryptocurrency includes a digital currency with transactions being verified and recorded by a decentralized system using cryptography.

11. The data processing system of claim 10, wherein the cryptocurrency includes one or more coins or one or more tokens.

12. The data processing system of claim 10, wherein the cryptocurrency provides access to funds from the payments in the custodial account.

13. The data processing system of claim 9, wherein the payments are received in a fiat currency.

14. The data processing system of claim 9, wherein the user purchases or becomes associated with an amount of cryptocurrency managed by the cryptocurrency exchange by paying through or to the cryptocurrency exchange.

15. One or more computer-readable memories having instructions embodied thereon, the instructions being executable by one or more processors to perform a method for providing a cryptocurrency secured by one or more loans, the method comprising:
receiving an identification of a pool of one or more bundled loans, wherein the one or more bundled loans includes two or more loans grouped together;
receiving an indication of payments of the one or more bundled loans in the pool, wherein the payments of the one or more bundled loans in the pool includes scheduled payments by one or more loan recipients toward interest or principal of the one or more bundled loans, wherein the payments of the one or more bundled loans in the pool are collected or stored in a custodial account;
receiving user information associated with a cryptocurrency exchange, the cryptocurrency exchange being associated with the cryptocurrency, the cryptocurrency being associated with the one or more bundled loans in the pool, wherein the cryptocurrency provides access to funds from the payments in the custodial account; and
transferring, to an account of a user associated with the user information, an amount of the payments of the one or more bundled loans in the pool based on cryptocurrency within the cryptocurrency exchange, wherein the amount of the payments distributed to the user is determined based on a percentage of the cryptocurrency owned or associated with the user, and wherein the amount of the payments distributed to the user are accessible to the user via a decentralized application.

16. The one or more computer-readable memories of claim 15, wherein the user purchases or becomes associated with an amount of cryptocurrency managed by the cryptocurrency exchange by paying through or to the cryptocurrency exchange, and wherein paying through or to the cryptocurrency exchange includes providing one or both of an amount of fiat currency or an amount of a different cryptocurrency.

17. The one or more computer-readable memories of claim 16, wherein the amount of fiat currency paid in exchange for the amount of cryptocurrency managed by the cryptocurrency exchange is determined based on one or more of a market rate, a predetermined rate, a rate associated with the different cryptocurrency, or a rate associated with the fiat currency.

18. The one or more computer-readable memories of claim 16, wherein the one or more bundled loans includes two or more loans grouped together comprising one or more of a mortgage, a home loan, a real estate loan, a commercial loan, a business loan, an automobile loan, a boat loan, an education loan, a debt consolidation loan, or a payday loan, and wherein the cryptocurrency purchased or associated with the user is stored via a virtual wallet associated with the user.

19. The one or more computer-readable memories of claim 15, wherein the cryptocurrency exchange includes a platform through which the cryptocurrency can be exchanged for one or more fiat currencies.

20. The one or more computer-readable memories of claim 15, wherein the amount of the payments distributed to the user is determined based on a percentage of the cryptocurrency owned or associated with the user.
